(19) United States
(12) Patent Application Publication
(10) Pub. No.: US 2004/0148386 A1
(43) Pub. Date: Jul. 29, 2004

(54) Dynamic CC/PP-based profile generation framework for network conditions assessment

(76) Inventors: Dennis Bushmitch, Somerset, NJ (US); Alan Kaplan, Princeton, NJ (US); Tsutomu Uenoyama, Kawasaki-shi (JP)

Correspondence Address: HARNESS, DICKEY & PIERCE, P.L.C., P.O. BOX 828, BLOOMFIELD HILLS, MI, 48303, US

(21) Appl. No.: 10/350,495

(22) Filed: Jan. 24, 2003

(51) Int. Cl. G06F 15/173

(52) U.S. Cl. 709/224; 709/226

(57) ABSTRACT

Network conditions are dynamically measured to extract quality of service condition information that is then translated based on a set of predetermined rules to generate a profile. The profile is configured as structured data about the dynamic state of the network. The profile can be propagated across the network to one or more different locations and to one or more different servers or end users, allowing those systems to adapt to network conditions in real-time.

### BACKGROUND OF THE INVENTION

The present invention relates generally to communication systems and networking. More particularly, the invention relates to a framework by which dynamic and real-time network-neighborhood information is made available to systems for application-level content adaptation. The invention may be implemented in a fashion that is compatible with CC/PP-based structures and vocabularies. The invention thus allows application-level quality of service control to occur in response to readable machine-formatted network-based information.

Communications systems and computer networks today must support a wide variety of different hardware devices and software applications, on both the client side and on the server side. As a consequence of this rich diversity, there is simply no single universal content format that can work in all situations. Displaying textual content on the small LCD display of a cellular telephone has very different requirements from displaying that same textual information on a laptop computer screen, for example. Similarly, delivering streaming video data over a 56K baud modem implicates a number of technical issues that are not found when delivery of the same media content is made using a T1 channel.

To address the fact that information appliances are not all created equal, the W3C organization has sponsored a Working Group to investigate how application-level content may be effected in a heterogeneous device environment (i.e., an environment in which information using devices, such as mobile devices, have different performance capabilities). The aforesaid Working Group has thus promulgated a Working Draft that describes a CC/PP (Composite Capabilities/Preference Profiles) structure and set of vocabularies. The CC/PP profile is a description of device capabilities and user preferences that can be used to guide the adaptation of content presented to that device. For more information regarding the CC/PP endeavor, reference may be had to the W3C Website, http://www.w3.org. The current Working Draft is published at http://www.w3.org/Mobile/cc/pp/.

The stated mission of the CC/PP Working Group endeavor is as follows: “As the number and variety of devices connected to the Internet grows, there is a corresponding increase in the need to deliver content that is tailored to the capabilities of different devices. . . . As a part of a framework for content adaptation and contextualization, a general purpose profile format is required that can describe the capabilities of a user agent and preferences of its user. CC/PP is designed to be such a format.”

Once suitable implementation details have been worked out and adopted, CC/PP should go a long way to solving the difficult problem of how to adapt application-level content in a heterogeneous device environment. However, distributing information across today's diverse communications and networking infrastructure carries challenges far beyond the device capability and user preference issues addressed by the CC/PP. One of the more challenging in this regard is the considerable real-time performance variability found in today's communication and network channels. Communication and network systems comprise many interconnected links. The conditions of those links greatly affect the real-time or dynamic performance of the communication system or network. Quite simply, the links, themselves, can introduce loss, delay and jitter into the information signal. In addition to link condition issues, other factors affecting the dynamic qualities of a network include: router buffers occupancy, link utilizations, and host reachability.

### SUMMARY OF THE INVENTION

The present invention provides a framework whereby dynamic network-neighborhood specific information may be captured and communicated to the information systems needing this information. A presently preferred embodiment utilizes XML-based profiles in general, and CC/PP-based profiles in particular. These profiles are extended to relate the dynamic network-neighborhood specific information. This information includes, but is not limited to, the conditions of links (e.g., loss, delay and jitter), router buffers occupancy, link utilizations, host reachability, and traffic characterization parameters (e.g., leaky bucket parameters). The information is obtained by utilizing, where possible, facilities of standard network evaluation tools and protocols. Such tools and protocols include RTP/RTCP, SNMP, ICMP (Ping), TCP/IP, UDP/IP and various other routing protocols.

In accordance with one aspect of the invention, this dynamic or real-time information is expressed in a CC/PP-compatible form, as in an RDF-based representation, that allows for structured, scalable representation of network profile information.

According to another aspect of the invention, dynamic network-specific information is obtained and translated into a form that can be understood by applications running on either the server or the client. Such representation can also be expressed in human readable form. The invention is thus capable of dynamically creating CC/PP-based profiles according to the CC/PP schema rules. Additional vocabularies designed for network attributes and their groupings are proposed to convey such dynamic information.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a system environment diagram useful in illustrating the nature of information communication networks today;

FIG. 2 is a communication system diagram illustrating some of the principles of the invention;

FIG. 3 is a framework architectural diagram illustrating one presently preferred embodiment of the invention;

FIG. 4 is a sequence diagram illustrating another embodiment of the invention; A

FIG. 5 is a flow chart diagram illustrating a presently preferred method of operation according to the invention.

### DETAILED DESCRIPTION OF THE PREFERRED EMBODIMENTS

The following description of the preferred embodiment(s) is merely exemplary in nature and is in no way intended to limit the invention, its application, or uses.

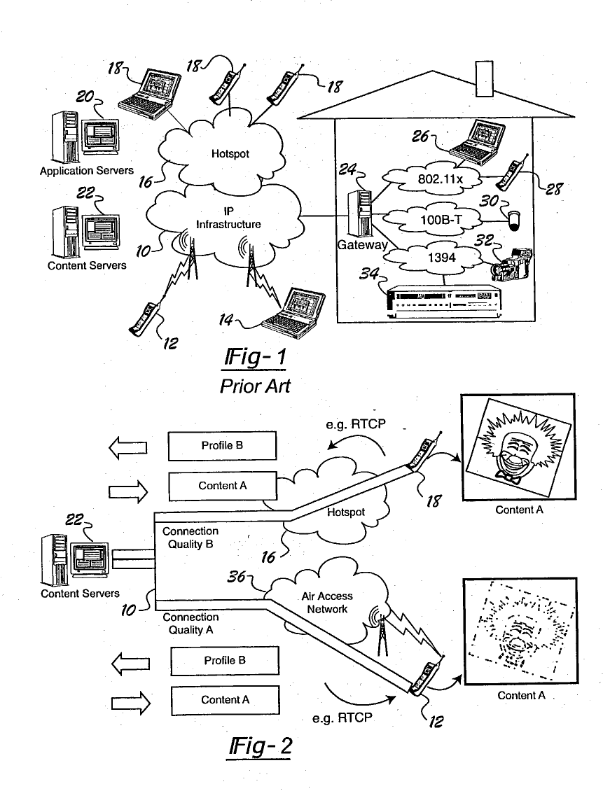

The present invention allows application-level quality of service control to occur in response to real-time network conditions. FIG. 1 illustrates an exemplary environment with which the invention may be used. It will, of course, be appreciated that the illustrated environment represents one common communication infrastructure. There are many other configurations with which the invention may be used. Referring to FIG. 1, a communication network is illustrated at 10. The communication network may be based on an Internet Protocol (IP) infrastructure, such as the infrastructure upon which the internet is based.

As illustrated, communication network 10 is capable of supporting communication using a variety of different devices and different communication channels. Illustrated in FIG. 1, a cellular telephone 12 and a laptop computer 14 communicate with the network 10. Such communication can be by conventional means, including hardwired links and wireless links. In addition, the network 10 may include one or more wireless communication hotspots 16 by which other mobile devices 18 communicate with the network. It will be appreciated that the various devices, and their respective communication channels, can be expected to vary substantially from one another. Some devices may have communication capabilities and features not found on the others. In addition, the respective communication channels may support different information bandwidths.

Also coupled to network 10 are other information infrastructure devices such as application servers 20 and content servers 22. These servers provide information over the network 10 that can be utilized by a variety of different users.

According to telecommunications standards, the network 10 comprises a plurality of interconnected links, operating through suitably figured routers, that communicate information over the network using a variety of different protocols for packet-based and streaming media information delivery. Coupled to one of these links, is gateway device 24. The gateway device may be considered as part of the communication network infrastructure. It provides connectivity with other end user devices using a variety of different protocols. Illustrated in FIG. 1, laptop computer 26 and cellular telephone 28 communicate using the 802.11× protocol. Device 30 communicates using an Ethernet protocol, such as the 100B-T protocol. Other consumer devices such as movie camera 32 and home entertainment system 34 communicate with gateway 24 using the IEEE 1394 standard. Of course, other communication protocols may also be used by providing a suitably configured gateway.

The communication infrastructure illustrated in FIG. 1 presents a significant engineering challenge: how to supply all of the various end user devices with suitably adapted content. Not only do the end user devices have different capabilities, the communication pathways coupling these devices to the network can be expected to have a significant difference from one pathway to the next. Moreover, the pathway difference is not static. As users log on to and off of the network, information throughput and bandwidth will fluctuate unpredictably. Packet loss, signal delay, signal jitter and other network-neighborhood artifacts are unavoidable. The present invention meets this challenge by developing a framework by which real-time network characteristics are monitored, captured and translated into structured data profiles that can then be propagated across the network and used for real-time application and content server control.

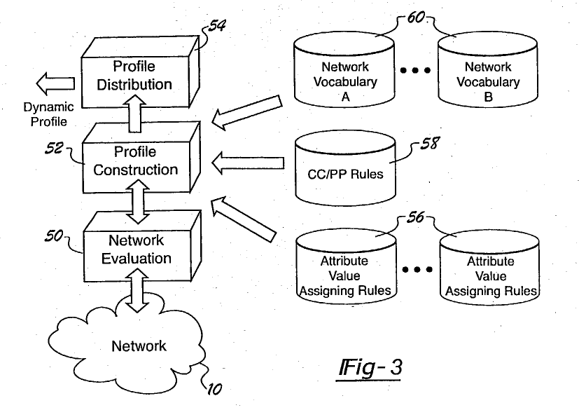

FIG. 2 illustrates an example of the inventive framework. In FIG. 2 cellular telephone 18 communicates with the network using a hotspot link 16; whereas cellular telephone 12 communicates with the network using an air access channel 36. Both cellular phones are being used to receive graphical content for display on their respective LCD displays. This graphical content is supplied by content server 22.

In the illustrated example shown in FIG. 2, the current or real-time conditions are such that telephone 18 has a much wider bandwidth and much better overall signal quality than telephone 12. Thus the content A being delivered to telephone 18 is currently much better than content A˜.

The inventive framework provides a means by which the real-time or dynamic qualities of the respective network connections can be communicated across the network in the form of profiles. As will be more fully explained below, these profiles are not bound to any single application server or content server. Rather, they are configured for propagation and storage across the network, in a distributed fashion if desired. In FIG. 2, the telephone devices 18 and 12 communicate with the network using the RTCP protocol, which includes a collection of documented quality of signal (QoS) metrics. These quality of signal metrics are monitored and translated by the invention to generate profiles (Profile B, Profile A) that are communicated to network 10. The content server 22 may then access these profiles to ascertain what the current network conditions happen to be.

The profiles are preferably configured as structured data based on a predefined schema and using a predefined vocabulary. In this regard, the invention can be implemented using a predefined XML vocabulary. In one presently preferred embodiment the structured data is expressed using a vocabulary that integrates with the CC/TP profile vocabulary developed for expressing device capabilities and preferences across the network. This latter embodiment is particularly desirable because it will allow dynamic network conditions to be communicated as part of the body of information being communicated regarding the static capabilities of the end user devices, themselves.

By way of example, the framework of the invention can define new CC/PP-compatible vocabularies for network entities, namely vocabularies that express additional component, attribute pairs that will reflect dynamic network conditions. Table I, below, illustrates an exemplary matrix of component, attribute pairs that may be used to communicate dynamic network-specific properties of the communication network infrastructure.

TABLE I

| Component | Attribute |
|---|---|
| Link Status | Link ID |
| Link Status | Average Loss |
| Link Status | Average Delay |
| Link Status | Average Jitter |
| Traffic Description | Traffic Type |
| Traffic Description | Traffic Rate |
| Traffic Description | Bucket Size |
| Traffic Description | Traffic Hurst |

In the above table, two components are described, Link Status and Traffic Description. For each of these two components, four attributes have been identified. It will be appreciated that the invention can use any number of different components and attributes, as needed, to express relevant dynamic network information. Thus, the component attribute pairs illustrated in Table I are merely for illustration purposes.

By way of further example, the vocabulary illustrated in Table I include a component called “LinkStatus” that has a set of quality of service-related attributes: “AverageLoss,” “AverageDelay,” and “AverageJitter.” In a working embodiment, AverageDelay can be measured by consulting an RTCP report to determine the average loss over a predetermined time. The value so ascertained would be assigned as the “value” of the corresponding attribute “AverageDelay” and reflected in the profile according to a predefined schema.

Reproduced below is an example of such a schema that may be used to implement this example. Note that in this example, the attribute AverageDelay has been assigned a value of “150”.

```
<RDF xmlns=“http://www.w3.org/TR/1999/some-rdf-syntax-123456789#”
        xmlns:PRF=“http://www.w3.org/some-profile-vocabulary#“>
    <Bag>
      <Description about=“LinkStatus”>
      <Defaults>
        <Description PRF:Vendor=“Matsushita”
            PRF:LinkID=“SuperFastLink”
            PRF:AverageLoss=“10”
            PRF:AverageDelay=“150”
            PRF:AverageJitter=“65”
      </Defaults>
    <Modifications>
      <Description PRF:AverageLoss=“15”/>
    </Modifications>
    </Description>
  .....
</RDF>
```

The above profile illustrates a presently preferred schema configuration that includes both a section devoted to “Defaults”—attributes for the communication link (e.g., the most common ones), and a section devoted to “Modifications” of the default attributes, reflecting the most recent change (after the measurement was conducted).

In the illustrated example, the average delay was determined by monitoring the network (or at least one link in the network) to develop information about said network, and then expressing that information as at least one state variable. In this case, RTCP was used to ascertain the average delay. Then a set of algorithmic and/or heuristic rules is applied to the state variable or variables to generate at least one attribute. The attribute is then translated into or placed as a data value into the profile according to the predefined profile schema. The information is thus stored in the profile as structured data about the dynamic state of said network. Thereafter, the profile may be propagated profile over the network for use or storage for later use.

The presently preferred profile is expressed as structured data in textual form (using XML or other suitable mark-up language). There are multiple mechanisms possible for profile propagation among devices and servers. These include http and sip delivery mechanisms, for example. The profiles may be delivered using push technology, pull technology, or combinations of the two. One possible system architecture realization of the invention will now be described in connection with FIG. 3.

Referring to FIG. 3, the inventive framework may include a network evaluation component 50, a profile construction component 52 and a profile distribution component 54. The network evaluation component 50 monitors network 10 to extract relevant network dynamic information using suitable facilities associated with standard network evaluation tools and protocols. Such facilities include those embodied in RTP/RTCP, SNMP, ICMP (Ping), TCP/IP, UDP/IP as well as various routing protocols. Typically these network evaluation tools will provide numeric data indicative of various real-time network conditions. Examples include, the number of packets lost during a predetermined time interval or the average bit rate for a predetermined time interval, and so forth. While these measurements indicate real-time network conditions, they are not themselves, suitable for propagation across the network for general purpose, device-independent consumption.

The profile construction component 52 is configured to use a data store or set of attribute value assigning rules 56. These rules are used to translate the raw network profile data into component, attribute pairs that are then expressed as structured data. Preferably, the profile construction component formulates this structured data by following a predefined set of profile formulation rules, such as CC/PP rules 58, and using a predefined data store or set of vocabularies, such as network vocabularies 60. The profile construction component is preferably designed for scalability. Thus additional attribute value assigning rules 56 and additional network vocabulary terminology 60 can be added, from time to time. This will allow the system to robustly evolve when new and emerging network technologies are adopted.

To better understand how the network condition assessment framework functions, refer to the exemplary sequence diagram of FIG. 4. In FIG. 4, a communication between content server 22 and user 14 has been illustrated. The communication may begin, for example, by user 14 issuing a request 100, to which content server issues reply 102. Using suitable assessment tools appropriate for the communication taking place, the network evaluator component 50 obtains raw quality of service information by examining the characteristics of the communication from user 14 to server 22 and from server 22 to user 14. This information may be obtained as the request 100 and reply 102 are taking place or at some other time. For illustration purposes, however, the acquisition of quality of service information (QoS information) has been separately illustrated at 104 and 106.

The network evaluator 50 then supplies the raw quality of service information to the profile construction component 52, which formulates a structured data representation of this information in the form of a profile. The profile construction component can be physically resident on the same system that performs network evaluation, however this is not a requirement. The profile construction component can be implemented using a different system, if desired. Thus, in FIG. 4 the quality of service attributes developed by network evaluation component 50 are delivered as quality attributes at 108 to the profile construction component 52. The profile is then disseminated or distributed across the network as at 110.

While it is possible for the profile to be delivered directly to content server 22, this is not a requirement of the framework. Rather, the profile is designed to be distributed over the network to one or more locations where the profile may be stored and/or utilized. In order to utilize the profile, a profile parser 150 examines the profile and extracts the attribute values associated with the corresponding network information components. Thus, in FIG. 4, profile parser 150 examines profile 110 and sends suitable control information to the content server 22 via message 112. Also for illustration purposes, the profile parser 150 may also send control information via 114 to the user device 14. It will be appreciated that the profile parser can exist in one or more different locations and can provide control instructions to one or more different servers and/or end user devices.

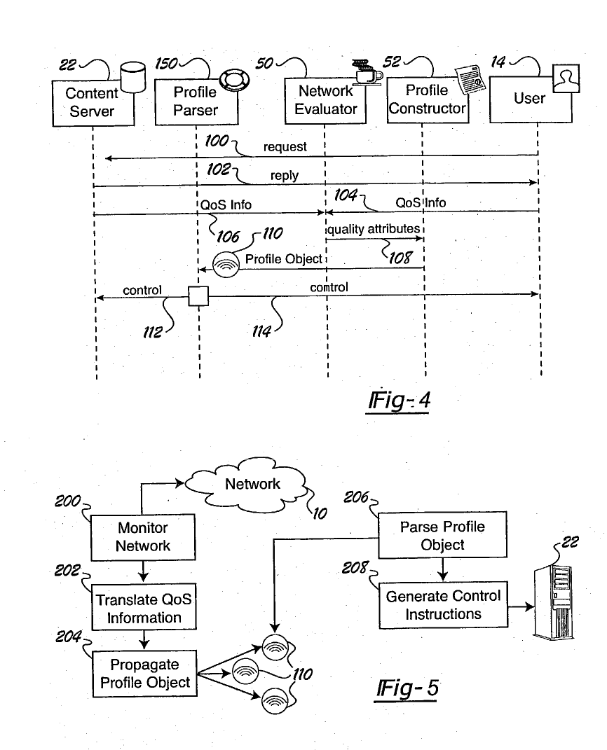

To further illustrate the framework and the associated operational methods associated with the framework, refer now to FIG. 5. FIG. 5 illustrates the basic steps performed in assessing dynamic network conditions, propagating profiles and then using those profiles for subsequent control. The process begins as step 200 at which the network 10 is monitored to obtain raw quality of service data. This raw quality of service data is then translated at step 202 to generate profiles that are then propagated across the network at step 204. As illustrated here, the profile can be propagated to one or more different locations across the network (3 locations are illustrated in FIG. 5).

When a network device such as content server 22 wishes to utilize the information contained in a profile, the object is examined and parsed at step 206. After parsing the profile, one or more control instructions are generated at 208 and these are supplied to the content server 22. The content server may, depending on its internal programming, alter the manner in which the information is sent to end users, based on the real-time network conditions that the respective users are currently experiencing.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for network condition assessment, comprising:
a network measurement system that monitors a network and develops real-time information about at least one quality of service condition of said network;
a translation module that processes said real-time information based on a set of predetermined rules to generate a profile comprising structured data about the dynamic state of said network.

2. The system of claim 1 wherein said structured data is configured according to a predefined schema.

3. The system of claim 1 wherein said structured data is expressed using a predefined XML vocabulary.

4. The system of claim 1 wherein said structured data is expressed using a predefined first vocabulary that is integrated with a predefined second vocabulary used to describe network device capabilities and preferences.

5. The system of claim 4 wherein said second vocabulary is the CC/PP vocabulary.

6. The system of claim 1 wherein said translation module employs a set of heuristic rules.

7. The system of claim 1 wherein said translation module employs a set of network evaluation rules.

8. The system of claim 1 wherein said profile is configured for storage across a distributed network environment.

9. The system of claim 1 further comprising an information processor coupled to said network;
said processor being configured to parse said profile and to alter its information processing behavior based on the dynamic state of said network as communicated by said profile.

10. A profile generation framework embodied in a networked computer system, comprising:
a network evaluation component configured to monitor network conditions and generate attribute values indicative of at least one quality of service condition of said network;
a profile construction component configured to construct at least one profile based on said attribute values; and
a profile distribution component configured to propagate said profile over said network.

11. The framework of claim 10 wherein said profile construction component employs a set of attribute assigning rules in constructing said at least one profile.

12. The framework of claim 11 wherein said attribute assigning rules are heuristic rules.

13. The framework of claim 10 wherein said profile construction component constructs said profile as structured data about the dynamic state of said network.

14. The framework of claim 13 wherein said structured data is expressed using a predetermined XML vocabulary.

15. The framework of claim 13 wherein said structured data is expressed using a predetermined vocabulary that is constrained with a predetermined device capability vocabulary.

16. The framework of claim 15 wherein said device capability vocabulary is a CC/PP vocabulary.

17. The framework of claim 10 wherein said profile construction component constructs said profile as structured data using a predetermined network vocabulary.

18. The framework of claim 10 wherein said network evaluation component employs network evaluation tools selected from the group consisting of RTP, RTCP, NSMP, ICMP, TCP/IP, UDP/IP, routing protocols and combinations thereof.

19. The framework of claim 10 wherein said network evaluation component monitors network link status properties selected from the group consisting of average loss, average delay, average jitter, and combinations thereof.

20. A method of assessing conditions of a network, comprising:
monitoring said network to develop quality of service information about said network;
translating said quality of service information into at least one profile comprising structured data about the dynamic state of said network; and
propagating said profile over said network.

21. The method of claim 20 wherein said structured data is configured according to a predefined schema.

22. The method of claim 20 wherein said structured data is expressed using a predefined XML vocabulary.

23. The method of claim 20 wherein said structured data is expressed using a predefined first vocabulary that is integrated with a predefined second vocabulary used to describe network device capabilities and preferences.

24. The method of claim 23 wherein said second vocabulary is the CC/PP vocabulary.

25. The method of claim 20 wherein said translating step employs a set of heuristic rules.

26. The method of claim 20 wherein said translating step employs a set of network evaluation rules.

27. The method of claim 20 wherein said profile is configured for storage across a distributed network environment.

28. The method of claim 20 further comprising parsing said profile and to altering the behavior an information processor based on the dynamic state of said network as communicated by said profile.

29. A method of assessing conditions of a network, comprising:
monitoring said network to develop information about said network and expressing said information as at least one state variable;
applying at least one predefined rule upon said at least one state variable to generate at least one attribute;
translating said at least one attribute into at least one profile comprising structured data about the dynamic state of said network; and
propagating said profile over said network.

30. The method of claim 29 wherein said at least one predefined rule is expressed algorithmically.

31. The method of claim 29 wherein said at least one predefined rule is expressed heuristically.

32. The method of claim 29 wherein said structured data is configured according to a predefined schema.

33. The method of claim 29 wherein said structured data is expressed using a predefined XML vocabulary.

34. The method of claim 29 wherein said structured data is expressed using a predefined first vocabulary that is integrated with a predefined second vocabulary used to describe network device capabilities and preferences.

35. The method of claim 32 wherein said second vocabulary is the CC/PP vocabulary.

36. The method of claim 29 wherein said profile is configured for storage across a distributed network environment.

37. The method of claim 29 further comprising parsing said profile and to altering the behavior an information processor based on the dynamic state of said network as communicated by said profile.
